(19) United States
(12) Patent Application Publication
(10) Pub. No.: US 2012/0041107 A1
(43) Pub. Date: Feb. 16, 2012

(54) WOOD FILLER COMPOSITION WITH KEVLAR

(75) Inventors: Yogeshbhai B. Patel, Reynoldsburg, OH (US); Van R. Foster, Westerville, OH (US)

(73) Assignee: ELMER'S PRODUCTS, INC., Westerville, OH (US)

(21) Appl. No.: 13/208,641

(22) Filed: Aug. 12, 2011

Related U.S. Application Data
(60) Provisional application No. 61/373,088, filed on Aug. 12, 2010.

(51) Int. Cl. C08L 97/02; C08K 7/28; C08L 77/10

(52) U.S. Cl. 524/14; 524/606; 524/608

(57) ABSTRACT

A wood filling composition that includes a predetermined weight percent of ceramic microspheres and a predetermined weight percent of polyaramid fiber, such as KEVLAR. This composition may also include a predetermined weight percent of at least one colored pigment; at least one bactericide; at least one mildewcide; at least one surfactant; at least one dispersant; at least one freeze-thaw stabilizer; at least one defoamer; at least one polymer; at least one adhesion promoter; at least one thickener; at least one filler; water; wood flour, glass bubbles; or combinations thereof.

### CROSS-REFERENCE TO RELATED APPLICATIONS

This patent application claims the benefit of U.S. Provisional Patent Application Ser. No. 61/373,088 filed on Aug. 12, 2010 and entitled “Wood Filling Composition with Kevlar”, the disclosure of which is hereby incorporated by reference herein in its entirety and made part of the present U.S. utility patent application for all purposes.

### BACKGROUND OF THE INVENTION

The present invention relates generally to a wood filling composition, and more specifically to a stainable wood filling composition that includes a relatively low level of Kevlar for improving the abrasion resistance of a dried film of the composition.

Wood fillers are traditionally used to repair blemishes, holes, and other defects in common household items such as wood furniture and/or wood flooring. Recent formulations research has improved the durability of such products by the inclusion of ceramic microspheres; see, for example, U.S. Pat. No. 6,956,069 (2005) and U.S. Pat. No. 7,504,447 (2009), both of which are incorporated by reference herein in their entirety for all purposes. However, for applications involving heavy traffic or wear there is still a need to further improve the long-term durability of such repair products.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a wood filling composition is provided. This composition includes a predetermined weight percent of ceramic microspheres; and a predetermined weight percent of polyaramid fiber, such as KEVLAR. This composition may also include a predetermined weight percent of at least one colored pigment; at least one bactericide; at least one mildewcide; at least one surfactant; at least one dispersant; at least one freeze-thaw stabilizer; at least one defoamer; at least one polymer; at least one adhesion promoter; at least one thickener; at least one filler; water; wood flour, glass bubbles; or combinations thereof.

In accordance with another aspect of the present invention, an alternate wood filling composition is provided. This composition includes a predetermined weight percent of ceramic microspheres; a predetermined weight percent of polyaramid fiber, such as KEVLAR; and a predetermined weight percent of at least one colored pigment. This composition may also include a predetermined weight percent of at least one bactericide; at least one mildewcide; at least one surfactant; at least one dispersant; at least one freeze-thaw stabilizer; at least one defoamer; at least one polymer; at least one adhesion promoter; at least one thickener; at least one filler; water; wood flour, glass bubbles; or combinations thereof.

In yet another aspect of this invention, another wood filling composition is provided. This composition includes a predetermined weight percent of ceramic microspheres; a predetermined weight percent of polyaramid fiber, such as KEVLAR; a predetermined weight percent of at least one colored pigment; and a predetermined weight percent of wood flour. This composition may also include a predetermined weight percent of at least one bactericide; at least one mildewcide; at least one surfactant; at least one dispersant; at least one freeze-thaw stabilizer; at least one defoamer; at least one polymer; at least one adhesion promoter; at least one thickener; at least one filler; water; glass bubbles; or combinations thereof.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### DETAILED DESCRIPTION OF THE INVENTION

Exemplary embodiments of the present invention are now described with reference to the examples provided herein. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

In accordance with the present invention, the incorporation of KEVLAR, a polyaramid fiber, improves the wear and abrasion resistance of wood filling products. KEVLAR is known to be a difficult material to blend into most formulas; however, when KEVLAR is mixed with the ceramic microspheres contained in the exemplary formulas of the present invention, the abrasiveness of the ceramic microspheres has been shown to facilitate dispersion of the KEVLAR into the formula. Thus, in the absence of ceramic microspheres, effective incorporation of KEVLAR would likely be problematic, especially for a waterborne formulation.

In addition to polyaramid fiber and KEVLAR, the wood filling compositions of the present invention include various additional ingredients that increase the effectiveness of the compositions or otherwise enhance their performance and stability. As previously stated, these ingredients include a predetermined weight percent of at least one colored pigment; at least one bactericide; at least one mildewcide; at least one surfactant; at least one dispersant; at least one freeze-thaw stabilizer; at least one defoamer; at least one polymer; at least one adhesion promoter; at least one thickener; at least one filler; water; wood flour, glass bubbles; or combinations thereof.

Having generally described this invention, a further understanding can be obtained by reference to certain specific examples detailed below, which are provided for purposes of illustration only and are not intended to be all inclusive or limiting unless otherwise specified. In addition to specific ingredients and general descriptions thereof, manufacturers or sources of the various ingredients are provided below, as is an exemplary manufacturing process or procedure for each formulation.

### Example 1

TABLE 1
WOOD FILLER MAX -- STAINABLE (TUB & TUBE FORMULA)

| | | % BY | | |
|---|---|---|---|---|
| | INGREDIENT | WEIGHT | DESCRIPTION | MANUFACTURER |
| 1 | Water | 12.000 | solvent | Fischer Scientific |
| 2 | Acticide LA | 0.100 | bactericide | Thor USA |
| 3 | Triton X-405 | 0.500 | surfactant | Dow Chemical |
| 4 | Tamol 851 | 0.500 | dispersant | Dow Chemical |
| 5 | Propylene Glycol | 1.500 | freeze-thaw stabilizer | Dow Chemical |
| 6 | Foamaster NXZ OR Defoamer XZ | 0.030 | defoamer | Cognis |
| 7 | Tint-Ayd CW-5509 OR Resotint Umber 2TC | 0.060 | colored pigment | Elementis/CRI |
| 8 | Aqua Yellow 597-49 OR Resotint Yellow TC | 0.250 | colored pigment | Elementis/CRI |
| 9 | Water | 1.000 | solvent | Fischer Scientific |
| 10 | Rhoplex E330 | 10.350 | polymer | Rohm & Haas |
| 11 | Rhoplex AC-2235M | 4.950 | polymer | Rohm & Haas |
| 12 | Kevlar 1F538 | 0.150 | polyaramid fiber | Dupont |
| 13 | Maple Wood Flour 4010 | 3.100 | wood flour | American Wood Fibers |
| 14 | #10 White OR Huber G325 | 32.350 | filler | Imerys OR Huber |
| 15 | Calwhite OR Hubercarb G6 | 15.800 | filler | Imerys OR Huber |
| 16 | Methocel E4M | 0.400 | thickener | Dow Chemical |
| 17 | Acticide 45 | 0.100 | mildewcide | Thor USA |
| 18 | Silane A-187 | 0.100 | adhesion promoter | Momentive |
| 19 | Extendosphere TG | 16.000 | ceramic microspheres | Sphere One/Kish Co. |
| 20 | Foamaster NXZ OR Defoamer XZ | 0.030 | defoamer | Cognis |
| 21 | Water - adjusting | 0.730 | solvent | Fischer Scientific |
| | | 100.00 | | |

Manufacturing Procedure for Example 1:
1. In a clean, dry tank, add items 1, 2, 3, 4, 5 and 6.
2. Add items 7 and 8 and use item 9 to rinse the container used to weigh the pigments.
3. Continue mixing and add items 10, 11, 12 and 13.
4. Continue mixing. Start high speed mixer and add items 14, 15 and 16. PRE-MIX ITEM 16 WITH SOME OF ITEM 15 TO AVIOD LUMPING. Mix thoroughly until lump free. Turn OFF high speed mixer at this stage but continue mixing with wiper and auger blades.
5. Add items 17, 18, 19 and 20.
6. Seal the lid tight on the mixing tank. Continue mixing with wiper blade only and turn on vacuum for two minutes.
7. Turn off vacuum and mixer and remove a sample for Q.C. check.
8. Adjust viscosity with item 21 as necessary by adding in small increments and keep testing until the viscosity is in specified range.

### Example 2

TABLE 2
WOOD FILLER MAX - NATURAL (TUBE FORMULA)

| | | % BY | | |
|---|---|---|---|---|
| | INGREDIENT | WEIGHT | DESCRIPTION | MANUFACTURER |
| 1 | Water | 10.328 | solvent | Fischer Scientific |
| 2 | Acticide LA | 0.100 | bactericide | Thor USA |
| 3 | Triton X-405 | 0.350 | surfactant | Dow Chemical |
| 4 | Tamol 851 | 0.350 | dispersant | Dow Chemical |
| 5 | Propylene Glycol | 1.500 | freeze-thaw stabilizer | Dow Chemical |
| 6 | Foamaster NXZ OR Defoamer XZ | 0.030 | defoamer | Cognis |
| 7 | Tint-Ayd CW-5003 Titanium Dioxide | 0.994 | colored pigment | Elementis |
| 8 | Tint-Ayd CW-5451 Light Lemon Yellow Oxide | 0.442 | colored pigment | Elementis |
| 9 | Water | 0.793 | solvent | Fischer Scientific |
| 10 | Rhoplex E330 | 10.271 | polymer | Rohm & Haas |
| 11 | Rhoplex AC-2235M | 4.910 | polymer | Rohm & Haas |
| 12 | Kevlar 1F538 | 0.150 | polyaramid fiber | Dupont |
| 13 | Maple Wood Flour 4010 | 3.082 | wood flour | American Wood Fibers |
| 14 | #10 White OR Huber G325 | 32.105 | filler | Imerys OR Huber |
| 15 | Calwhite OR Hubercarb G6 | 12.490 | filler | Imerys OR Huber |
| 16 | Methocel E4M | 0.350 | thickener | Dow Chemical |
| 17 | Acticide 45 | 0.100 | mildewcide | Thor USA |
| 18 | Silane A-187 | 0.100 | adhesion promoter | Momentive |
| 19 | Extendosphere TG | 17.870 | ceramic microspheres | Sphere One/Kish Co. |
| 20 | Foamaster NXZ OR Defoamer XZ | 0.030 | defoamer | Cognis |
| 21 | 3M Glass Bubbles K20 | 0.994 | thickening agent | 3M |
| 22 | Water | 0.492 | solvent | Fischer Scientific |
| 23 | Water - adjusting | 2.169 | solvent | Fischer Scientific |
| | | 100.00 | | |

Manufacturing Procedure for Example 2:
1. In a clean, dry tank, add items 1, 2, 3, 4, 5 and 6.
2. Add items 7 and 8 and use item 9 to rinse the container used to weigh the pigments.
3. Continue mixing and add items 10, 11, 12 and 13.
4. Continue mixing. Start high speed mixer and add items 14, 15 and 16. HINT: PRE-MIX ITEM 16 WITH SOME OF ITEM 15 TO AVIOD LUMPING. Mix thoroughly until lump free. Turn OFF high speed mixer at this stage but continue mixing with wiper and auger blades.
5. Add items 17, 18, 19 and 20.
6. Add item 21 and immediately follow up with item 22.
7. Seal the lid tight on the mixing tank. Continue mixing with wiper blade only and turn on vacuum for two minutes.
8. Turn off vacuum and mixer and remove a sample for Q.C. check.
9. Adjust viscosity with item 23 as necessary by adding in small increments and keep testing until the viscosity is in specified range.

### Example 3

TABLE 3
WOOD FILLER MAX - CHERRY (TUBE FORMULA)

| | | % BY | | |
|---|---|---|---|---|
| | INGREDIENT | WEIGHT | DESCRIPTION | MANUFACTURER |
| 1 | Water | 10.421 | solvent | Fischer Scientific |
| 2 | Acticide LA | 0.100 | bactericide | Thor USA |
| 3 | Triton X-405 | 0.350 | surfactant | Dow Chemical |
| 4 | Tamol 851 | 0.350 | dispersant | Dow Chemical |
| 5 | Propylene Glycol | 1.500 | freeze-thaw stabilizer | Dow Chemical |
| 6 | Foamaster NXZ OR Defoamer XZ | 0.030 | defoamer | Cognis |
| 7 | Tint-Ayd CW-5509 Burnt Umber OR Resotint | 1.760 | colored pigment | Elementis or CRI |
| | Umber 2TC | | | |
| 8 | Tint-Ayd CW-5451 Light Lemon Yellow Oxide | 0.330 | colored pigment | Elementis |
| 9 | Tint-Ayd CW-5611 Red Iron Oxide Medium | 0.110 | colored pigment | Elementis |
| 10 | Tint-Ayd CW-5317 Tinting Black | 0.022 | colored pigment | Elementis |
| 11 | Water | 0.803 | solvent | Fischer Scientific |
| 12 | Rhoplex E330 | 10.325 | polymer | Rohm & Haas |
| 13 | Rhoplex AC-2235M | 4.950 | polymer | Rohm & Haas |
| 14 | Kevlar 1F538 | 0.150 | polyaramid fiber | Dupont |
| 15 | Maple Wood Flour 4010 | 3.103 | wood flour | American Wood Fibers |
| 16 | #10 White OR Huber G325 | 32.503 | filler | Imerys OR Huber |
| 17 | Calwhite OR Hubercarb G6 | 12.582 | filler | Imerys OR Huber |
| 18 | Methocel E4M | 0.350 | thickener | Dow Chemical |
| 19 | Acticide 45 | 0.100 | mildewcide | Thor USA |
| 20 | Silane A-187 | 0.100 | adhesion promoter | Momentive |
| 21 | Extendosphere TG | 17.583 | ceramic microspheres | Sphere One/Kish Co. |
| 22 | Foamaster NXZ OR Defoamer XZ | 0.030 | defoamer | Cognis |
| 23 | 3M Glass Bubbles K20 | 1.000 | thickening agent | 3M |
| 24 | Water | 0.502 | solvent | Fischer Scientific |
| 25 | Water - adjusting | 0.946 | solvent | Fischer Scientific |
| | | 100.00 | | |

Manufacturing Procedure for Example 3:
1. In a clean, dry tank, add items 1, 2, 3, 4, 5 and 6.
2. Add items 7, 8, 9, 10 and use item 11 to rinse the container used to weigh the pigments.
3. Continue mixing and add items 12, 13, 14 and 15.
4. Continue mixing. Start high speed mixer and add items 16, 17 and 18. HINT: PRE-MIX ITEM 18 WITH SOME OF ITEM 17 TO AVIOD LUMPING. Mix thoroughly until lump free. Turn OFF high speed mixer at this stage but continue mixing with wiper and auger blades.
5. Add items 19, 20, 21 and 22.
6. Add item 23 and immediately follow up with item 24.
7. Seal the lid tight on the mixing tank. Continue mixing with wiper blade only and turn on vacuum for two minutes.
8. Turn off vacuum and mixer and remove a sample for Q.C. check.
9. Adjust viscosity with item 25 as necessary by adding in small increments and keep testing until the viscosity is in specified range.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) A wood filling composition, comprising:
(a) a predetermined weight percent of ceramic microspheres; and
(b) a predetermined weight percent of polyaramid fiber.

2) The wood filling composition of claim 1, further comprising a predetermined weight percent of at least one colored pigment.

3) The wood filling composition of claim 1, further comprising a predetermined weight percent of wood flour.

4) The wood filling composition of claim 1, further comprising a predetermined weight percent of at least one bactericide and at least one mildewcide.

5) The wood filling composition of claim 1, further comprising a predetermined weight percent of at least one surfactant.

6) The wood filling composition of claim 1, further comprising a predetermined weight percent of at least one dispersant.

7) The wood filling composition of claim 1, further comprising a predetermined weight percent of at least one freeze-thaw stabilizer.

8) The wood filling composition of claim 1, further comprising a predetermined weight percent of at least one defoamer.

9) The wood filling composition of claim 1, further comprising a predetermined weight percent of at least one polymer.

10) The wood filling composition of claim 1, further comprising a predetermined weight percent of at least one adhesion promoter.

11) The wood filling composition of claim 1, further comprising a predetermined weight percent of at least one thickener.

12) The wood filling composition of claim 1, further comprising a predetermined weight percent of glass bubbles.

13) The wood filling composition of claim 1, further comprising a predetermined weight percent of water.

14) A wood filling composition, comprising:
(a) a predetermined weight percent of ceramic microspheres;
(b) a predetermined weight percent of polyaramid fiber; and
(c) a predetermined weight percent of at least one colored pigment.

15) The wood filling composition of claim 14, further comprising a predetermined weight percent of wood flour.

16) The wood filling compositions of claim 14, further comprising a predetermined weight percent of at least one bactericide; at least one mildewcide; at least one surfactant; at least one dispersant; at least one freeze-thaw stabilizer; at least one defoamer; at least one polymer; at least one adhesion promoter; at least one thickener; at least one filler; water; or combinations thereof.

17) The wood filling composition of claim 14, further comprising a predetermined weight percent of glass bubbles.

18) A wood filling composition, comprising:
(a) a predetermined weight percent of ceramic microspheres;
(b) a predetermined weight percent of polyaramid fiber;
(c) a predetermined weight percent of at least one colored pigment; and
(d) a predetermined weight percent of wood flour.

19) The wood filling compositions of claim 18, further comprising a predetermined weight percent of at least one bactericide; at least one mildewcide; at least one surfactant; at least one dispersant; at least one freeze-thaw stabilizer; at least one defoamer; at least one polymer; at least one adhesion promoter; at least one thickener; at least one filler; water; or combinations thereof.

20) The wood filling composition of claim 18, further comprising a predetermined weight percent of glass bubbles.
